(19) United States
(12) Patent Application Publication
(10) Pub. No.: US 2020/0123031 A1
(43) Pub. Date: Apr. 23, 2020

(54) METHOD OF COAGULATION SEDIMENTATION PROCESS

(71) Applicant: Hisaaki OCHIAI, Tokyo (JP)

(72) Inventor: Hisaaki OCHIAI, Tokyo (JP)

(21) Appl. No.: 16/603,909

(22) PCT Filed: Mar. 27, 2018
(86) PCT No.: PCT/JP2018/012331

§ 371 Date: Nov. 22, 2019

(30) Foreign Application Priority Data
Apr. 17, 2017 (JP) 2017-081025

(51) Int. Cl. C02F 1/52; B01D 21/01; B01D 21/08; B01D 21/28; B01D 21/00

(52) U.S. Cl. CPC C02F 1/5236; B01D 21/01; B01D 21/0042; B01D 21/28; B01D 21/08

(57) ABSTRACT

A method of coagulation sedimentation process for water to be treated, including a process of selecting the G_{R} value and T_{R} value that allow energy consumption for rapid agitation to be reduced and turbidity of sedimentation-treated water to be lowered. The method including: a step of injecting an inorganic coagulant into the water to be treated and a rapid agitation step in which injection is carried out, by first setting the same value of G_{R}·T_{R} with respect to the G_{R} value in a range of 150 s⁻¹ to 2000 s⁻¹ and the T_{R} value in a range of 1 minute to 5 minutes, which are ranges commonly employed in the prior art, and then selecting the G_{R} value with a smaller numerical value than the G_{R} values in this range, and selecting the T_{R} value with a large numerical value that is longer than 10 minutes.

### TECHNICAL FIELD

The present invention relates to a method of coagulation sedimentation process for water to be treated in which an inorganic coagulant is injected into the water to be treated such as river water, rain water and water for and discharged from plants, through a micro flocculation step of agglomerating fine suspended particles contained in the water to be treated to form micro flocs by rapid agitation and a flocculation step of flocculating the micro flocs by being brought into contact with existing flocs, thereby the flocs formed in the flocculation step are settled and separated at a sedimentation basin to obtain sedimentation-treated water, and the present invention is directed to the method of coagulation sedimentation process for the water to be treated having as a feature the selection of a rapid agitation intensity and rapid agitation time.

### BACKGROUND ART

In the rapid agitation, as the first step of the method of the coagulation sedimentation process for the water to be treated, the following rapid agitation intensity G_{R} value is defined (the units being reciprocal seconds, which can be represented by s⁻¹).

$${G}_{R} = \sqrt{\frac{( C \cdot A \cdot {v}^{3} )}{2 \cdot γ \cdot V}} \qquad [ Formula 1 ]$$

### Where:

C: two-dimensional agitation constant,

A: agitation blade area (m²),

v: agitation blade peripheral speed (m/s),

γ: kinematic viscosity coefficient (m²/s),

V: agitation tank volume (m³)

A T_{R} value is defined as the time during which agitation is continued at the aforementioned G_{R} value, with seconds or minutes as the units.

For a vast majority of purification processes, the G_{R} value in a range of 150 s⁻¹ to 2000 s⁻¹ is employed, and the T_{R} value in the range of 1 minute to 5 minutes is set.

In Japanese Patent Application No. 2008-158743, the present applicant has proposed an invention with a following basic construction (hereunder referred to as “prior invention”), and has already established with a patent right of Japanese Patent No. 4316671 for the prior invention:

A coagulation sedimentation process for water to be treated comprising

an inorganic coagulant injection step for injecting an inorganic coagulant into water to be treated,

a micro flocculation step for mixing and agitating in a rapid agitation tank the water to be treated into which the inorganic coagulant has been injected to micro-flocculate in advance fine suspended particles in the water to be treated,

a flocculation step including a step in which the micro flocks are further flocculated by being brought into contact with existing flocks in a sedimentation basin, and

a sedimentation separation step for effecting the sedimentation and separation of the flocks in the sedimentation basin,

wherein as a final stage of the flocculation step, a flock-forming inclined plate whose pitch width is from 5 mm or more to 50 mm or less is provided and the inorganic coagulant at a stage after the micro flocculation step is limited for the used amount so that the turbidity of the water to be treated after passage through the inclined plate at a ratio to that before passage is 4/5 or less.

The prior invention is achieved by limiting the amount of inorganic coagulant used in the micro flocculation step, and as a result, it exhibits actions and effects whereby the micro flocs that remain in the clear water is finer and of higher density than in the prior art, thus allowing high-quality clear water to be obtained while also reducing the amount of sludge generated associated with use of the inorganic coagulant, which makes it possible to also reduce the complexity of sludge treatment.

According to the prior invention, however, the G_{R} value is expected to be in the numerical range of 150 s⁻¹ to 2000 s⁻¹, since the rapid agitation tank used is similar to those commonly employed, while the T_{R} value is expected to be and is set in the numerical range of approximately 1 minute to 10 minutes.

In fact, in Example 1 of the prior invention, the G_{R} value is set to 1250 s⁻¹ and the T_{R} value is set to 7.3 minutes, and in Example 2, the G_{R} value is set to 1500 s⁻¹ and the T_{R} value is set to 0.96 minutes, i.e. less than 1 minute, and 2.93 minutes.

In the prior invention, the reason for setting the upper limit for the T_{R} value to be longer than has been generally established in the prior art is that the amount of coagulant used is less than in the prior art, such that it may become necessary to set a longer time for the micro flocculation.

In coagulation sedimentation treatment of water to be treated, the following Smoluchowski equation generally holds:

dN/dt=−α(4GΦ/π)·N [Formula 2]

### Where:

N: number (i.e. concentration) of the micro flocs or floc particles per unit volume,

α: collision efficiency based on effect of the inorganic coagulant,

G: agitation intensity,

Φ: mean volume of the micro flocs or the floc particles per unit volume

The general solution to this formula is as represented by N in the following:

N=A exp(−kt) [Formula 3]

### Where:

A: initial value of N at t=0,

k=4αGΦ/π

In the rapid agitation, if it is assumed that:

kT_{R}=4αΦG_{R}T_{R}/π [Formula 4]

then the concentration N of the micro flocs or the flocs that determine the turbidity at the completion stage of the rapid agitation is determined by the value of G_{R}·T_{R}, i.e. the product of the G_{R} value and the T_{R} value.

On the other hand, in the rapid agitation, a following relational expression holds between the agitation energy P and the rapid agitation intensity G_{R} value per unit volume and per unit time:

P=μG_{R}² [Formula 5]

Where μ: viscosity coefficient (kg/m·s)

This relational expression clearly supports a concept that P depends on selection of the G_{R} value.

When the G_{R} value has increased to or beyond a prescribed level during actual rapid agitation, this may result in a problem of increased turbidity at the stage when the rapid agitation step has been completed.

Explaining concretely, a graph in FIG. 4 shows a state of change in the concentration and the turbidity of different particle sizes at the stage after completion of a slow agitation step in which the slow agitation intensity G_{S} value in a subsequent slow agitation tank has been set to 25 s⁻¹ and a slow agitation time T_{S} value has been set to 20 minutes, which is after producing water to be treated for testing, by injection of 20 mg/L of kaolin in a testing rapid agitation tank having a cuboid shape with 0.2 m sides and injecting 13.0 mg/L of PAC (Poly Aluminum Chloride) as a coagulant, with the G_{R} value set to the range of 150 s⁻¹ to 2000 s⁻¹ and the T_{R} value set to 5 minutes.

The slow agitation tank is provided after the rapid agitation tank for the experiment represented by the graph in FIG. 4, based on the construction of the prior art, but despite this subsequent slow agitation, FIG. 4 shows that the turbidity increased when the G_{R} value was greater than 1000.

It is understood by the reason for the increased turbidity that when the G_{R} value has increased above 1000, larger micro flocs of 15 μm or greater formed by aggregation of the fine suspended particles were broken up by the rapid agitation, and the micro flocs increased due to numerous smaller particle sizes.

Actually, in the testing rapid agitation tank having the cuboid shape with 0.2 m sides as mentioned above, when the G_{R} value is set to 1500 s⁻¹ with injection of 1 mg/L of kaolin and 5 mg/L of PAC, as shown in FIG. 5, the larger micro flocs with particle sizes of 15 μm or greater decreases, while conversely the micro flocs with particle sizes in respective ranges of less than 1 μm, 1 to 3 μm, 3 to 7 μm, and 7 to 10 μm successively increases, during the period where the T_{R} value is approximately 5 minutes.

With the turbidity shown in FIG. 4, the state in which the G_{R} value is successively decreasing to 1000 s⁻¹ and the degree of decrease is becoming successively slower, basically supports a concept that the concentration N of the micro flocs or the flocs is an exponential function of the G_{R} value, as represented by [Formula 3] and [Formula 4], but the fact that the turbidity increases again at the stage where the G_{R} value has exceeded 1000 s⁻¹ grounds on reasons that the larger micro floc particles with particle sizes of 15 μm or greater decrease by breaking up, and that the increasing number of smaller micro floc particles leads to a successively smaller value for Φ, which is the mean volume of the micro flocs or the floc particles.

Nevertheless, in the prior invention, as in the prior art as well, no consideration is given to selecting appropriate G_{R} value and T_{R} value that reduce energy consumption required for the rapid agitation while also preventing breakup of the larger micro flocs, and that can decrease the turbidity compared to ordinary use according to the prior art, upon placing a focus on a fact that the turbidity at the final stage of the rapid agitation also depends on the value of G_{R}·T_{R}.

### PRIOR ART DOCUMENTS

### Patent Documents

[Patent Document 1] Japanese Patented Official Gazette No. 4316671

### SUMMARY OF INVENTION

### Technical Problem

It is an object of the present invention to provide a construction for the method of coagulation sedimentation process for water to be treated, wherein focus is on the value of G_{R}·T_{R} for rapid agitation, selecting a rapid agitation intensity G_{R} value and rapid agitation time T_{R} value that allow energy consumption for rapid agitation to be reduced and that prevent breakup of larger micro flocs.

### Solution to Problem

For achieving the object, this invention stands on the following basic constructions (1) and (2):

(1) A method of coagulation sedimentation process for water to be treated, the process having an inorganic coagulant injection step of injecting an inorganic coagulant into water to be treated, a micro flocculation step of fine suspended particles in the water to be treated with mixing and agitating the water to be treated in a rapid agitation tank into which the inorganic coagulant has been injected to micro-flocculate in advance, a flocculation step including a step in which micro flocs are further flocculated according to contact with already existing flocs in a sedimentation basin, and a sedimentation separation step of effecting sedimentation and separation of the flocs in the sedimentation basin, wherein a G_{R} value as a rapid agitation intensity and a T_{R} value as a rapid agitation time, represented by following formulas, are selected by following processes:

$${G}_{R} = \sqrt{\frac{( C \cdot A \cdot {v}^{3} )}{2 \cdot γ \cdot V}} \qquad [ Formula 6 ]$$

Where C: agitation constant, A: agitation blade area (m²), v: agitation blade peripheral speed (m/s), γ: kinematic viscosity coefficient (m²/s), V: agitation tank volume (m³)
1. In order to satisfy a necessary prescribed level for a concentration of the micro flocs and the fine suspended particles with particle sizes of 0.5 to 1.0 μm at a stage where a rapid agitation step has been completed, initial values for the G_{R} value and the T_{R} value are respectively set to a G_{R0} value in a range of 150 s⁻¹ to 450 s⁻¹ and 5 minutes, and a minimum G_{R1} value is set with 75 s⁻¹ as a lower limit and a maximum T_{R1} value is set with 10 minutes as a lower limit with G_{R1}·T_{R1}=G_{R0}·5 minutes being satisfied,
2. Within 5 minutes after starting a rapid agitation operation, after having detected a G_{R2}′ value which is an upper limit for the G_{R} value where there is no decrease in the concentration of the micro flocs and the fine suspended particles with particle sizes of 0.5 to 1.0 μm at the stage where the rapid agitation step has been completed, a maximum G_{R2} value and a minimum T_{R2} value are set by a relational expression of G_{R2}′×5 minutes=G_{R2}·T_{R2}, and,
3. As operating conditions at the rapid agitation tank, a G_{R3} value and a T_{R3} value are selected to satisfy G_{R1}≤G_{R3}≤G_{R2}, T_{R2}≤T_{R3}≤T_{R1}, and to satisfy G_{R3}·T_{R3}≤600,000.

(2) A method of coagulation sedimentation process for water to be treated, the process having an inorganic coagulant injection step of injecting an inorganic coagulant into water to be treated, a micro flocculation step of fine suspended particles in the water to be treated with mixing and agitating the water to be treated in a rapid agitation tank into which the inorganic coagulant has been injected to micro-flocculate in advance, a flocculation step including a step in which micro flocs are further flocculated according to contact with already existing flocs in a sedimentation basin, and a sedimentation separation step of effecting sedimentation and separation of the flocs in the sedimentation basin, wherein a G_{R} value as a rapid agitation intensity and a T_{R} value as a rapid agitation time, represented by following formulas, are selected by following processes:

$${G}_{R} = \sqrt{\frac{( C \cdot A \cdot {v}^{3} )}{2 \cdot γ \cdot V}} \qquad [ Formula 7 ]$$

Where C: agitation constant, A: agitation blade area (m²) , v: agitation blade peripheral speed (m/s), γ: kinematic viscosity coefficient (m²/s), V: agitation tank volume (m³)
1. In order to satisfy a necessary prescribed level for turbidity at a stage where a rapid agitation step has been completed, initial values for the G_{R} value and the T_{R} value are respectively set to a G_{R0} value in a range of 150 s⁻¹ to 450 s⁻¹ and 5 minutes, and a minimum G_{R1} value is set with 75 s⁻¹ as a lower limit and a maximum T_{R1} value is set with 10 minutes as a lower limit with G_{R1}·T_{R1}=G_{R0}=5 minutes being satisfied,
2. Within 5 minutes after starting a rapid agitation operation, after having detected a G_{R2}′ value which is an upper limit for the G_{R} value where there is no increase in the turbidity at a stage where the rapid agitation step has been completed, a maximum G_{R2} value and a minimum T_{R2} value are set by a relational expression of G_{R2}′×5 minutes=G_{R2}·T_{R2}, and,
3. As operating conditions at the rapid agitation tank, a G_{R3} value and a T_{R3} value are selected to satisfy G_{R1}≤G_{R3}≤G_{R2}, T_{R2}≤T_{R3}≤T_{R1}, and to satisfy G_{R3}·T_{R3}≤600,000.

### Advantageous Effects of Invention

According to the present invention which is based on basic constructions (1) and (2), it is possible, by selecting appropriate values for the G_{R} value and T_{R} value, to reduce energy consumption for the rapid agitation and to achieve suitable turbidity without breakup of larger micro flocs that have been formed during the rapid agitation process, compared to a normal state of use in which, the G_{R} value is set to 150 s⁻¹ to 2000 s⁻¹ and the T_{R} value is set to 1 minute to 5 minutes, and the state of use according to the prior invention in which the G_{R} value is set to 150 s⁻¹ to 2000 s⁻¹ and the T_{R} value is set to approximately 1 minute to 10 minutes.

In addition, it is possible to eliminate a need for a slow agitation tank, since agitation conditions approach those of the slow agitation tank, thus lowering a remaining amount of the fine suspended particles and the micro flocs with particle sizes of 3.0 μm and smaller and causing aggregation to a state with particle sizes of 3.0 μm and greater, so that the turbidity is decreased at the stage where the rapid agitation step has been completed, and the G_{R} value and the T_{R} value are selected to approach a slow agitation state.

### BRIEF DESCRIPTION OF DRAWINGS

FIG. 1 is a block diagram of a treatment flow process on which the present invention is based.

FIG. 2 is a pair of graphs representing change in concentration of micro flocs and fine suspended particles with particle sizes of 0.5 to 1.0 μm at different G_{R} values, using raw water obtained from the Yodo river as water to be treated, where (a) shows horizontal axis of the T_{R} value and (b) shows horizontal axis of G_{R}·T_{R}.

FIG. 3 is a graph showing a comparison of the remaining states of the micro flocs with different particle sizes where the value of G_{R}·T_{R} was set to 450 s⁻¹×5 minutes or 150 s⁻¹×15 minutes (however, with particle sizes of 0.5 to 1.0 μm, the micro flocs partially remain in a state of the fine suspended particles instead of total flocculation), using raw water obtained from the Yodo river as the water to be treated.

FIG. 4 is a graph showing the state of change in concentration and the state of change in turbidity of the micro flocs with different particle sizes corresponding to the G_{R} values (however, with particle sizes of 0.5 to 1.0 μm, the micro flocs partially remain in the state of the fine suspended particles instead of the total flocculation), after injecting 20 mg/L of kaolin and 13.0 mg/L of PAC into a testing rapid agitation tank, following this with a slow agitation tank, and setting the T_{R} value to 5 minutes.

FIG. 5 is a graph showing change in the remaining amount of the micro flocs with different particle sizes (however, with particle sizes of 0.5 to 1.0 μm, the micro flocs partially remain in the state of the fine suspended particles instead of the total flocculation), corresponding to variation in the T_{R} value with the G_{R} value set to 1500 s⁻¹, in the same testing rapid agitation tank as in FIG. 4.

FIG. 6 is a graph showing the state of change in the number of the larger micro floc particles exceeding 30 μm, corresponding to variation in the T_{R} value with the G_{R} value set to 1500 s⁻¹, and STR value in the same testing rapid agitation tank as in FIG. 4.

### DESCRIPTION OF EMBODIMENTS

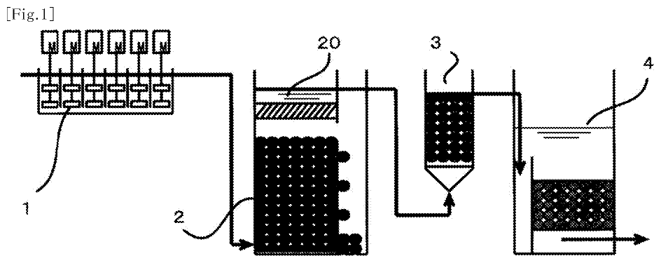

The present invention achieves successive purification of water to be treated by employing the treatment flow process as shown in FIG. 1, and specifically a rapid agitation tank 1, a high-speed coagulation sedimentation basin 2 with a floc-forming inclined plate 20, a coarse grain filtration tank 3 and a sand filtration tank 4.

Technical significance of the basic constructions (1) and (2) will be explained at first.

Particle sizes of suspended particles in the water to be treated are generally distributed across a range of 0.5 μm to 60 μm, but the proportion consisting of micro flocs and fine suspended particles with particle sizes of 0.5 to 1.0 μm exceeds 90% in almost all the water to be treated.

This proportion is especially notable in countries with developed water supplies under advanced water management, such as in Japan and Europe and the Unites States.

In coagulation sedimentation treatment of the water to be treated, therefore, a function of allowing decrease in turbidity depends on degree to which remaining amount of the micro flocs and the fine suspended particles can be decreased by aggregation of the micro flocs and the fine suspended particles with particle sizes of 0.5 to 1.0 μm.

Explaining this point in detail, the concentration N of particles due to flocculation and micro flocculation, according to the general solution of the above-mentioned Smoluchowski equation, is in a proportional relationship with the turbidity, but in the vast majority of cases 4αΦG_{R}T_{R}/π is much smaller than 1, i.e. 4αΦG_{R}T_{R}/π<<1 holds, and such that [Formula 3] can be approximately represented as:

N≈A(1−4αΦG_{R}T_{R}/π). [Formula 8]

The value of G_{R}·T_{R} and a degree of decrease in N, i.e. the degree of decrease in the turbidity, are proportionally related by this approximation.

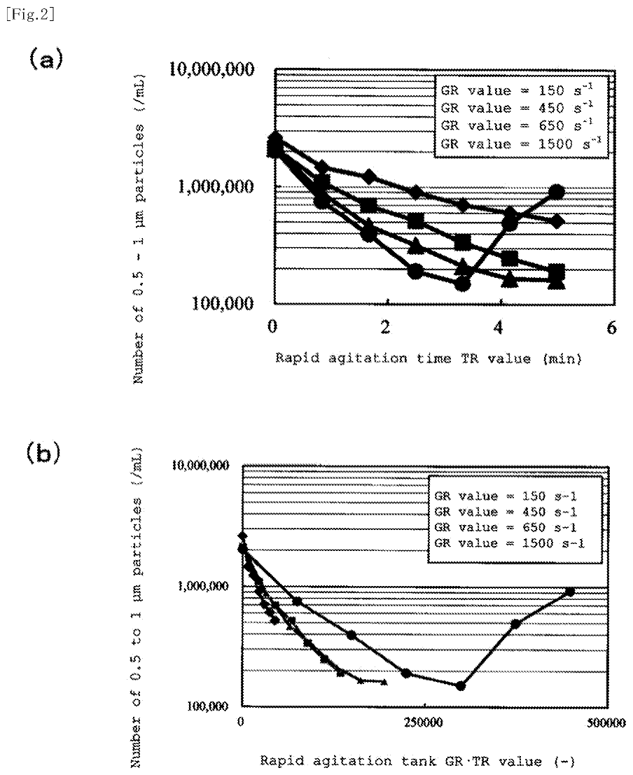

On the other hand, FIG. 2(a) shows cases where the G_{R} value is respectively set to 150 s⁻¹, 450 s⁻¹, 650 s⁻¹, or 1500 s⁻¹ and the T_{R} value is successively set to 5 minutes, when using raw water obtained from the Yodo river as the water to be treated, and it is seen that when the G_{R} value was 150 s⁻¹, 450 s⁻¹ or 650 s⁻¹ as shown in FIG. 2(b) where the value of G_{R}·T_{R} is on the abscissa, an increase in the value of G_{R}·T_{R} on which the turbidity depends, and the decrease in the micro flocs and the fine suspended particles with particle sizes of 0.5 to 1.0 μm, are approximately proportionally related.

Even when the G_{R} value is 1500 s⁻¹, the degree of reduction in the concentration of the micro flocs and the fine suspended particles with particle sizes of 0.5 to 1.0 μm was greater compared to other cases, but the increase in the value of G_{R}·T_{R} was still in approximately the proportional relationship up until the T_{R} value reached approximately 3.5 minutes.

Such a proportional relationship indeed grounds on a reason that the turbidity of sedimentation-treated water depends on the remaining amount of the micro flocs and the fine suspended particles with particle sizes of 0.5 to 1.0 μm, similar to the value of G_{R}·T_{R} in [Formula 8].

Such a dependence is understood by standing on a fact that the amount of the micro flocs and the fine suspended particles with particle sizes of 0.5 to 1.0 μm is clearly a relatively greater amount than flocs with sizes exceeding 1.0 μm, and since their particle sizes are smaller, they significantly influence the turbidity due to their major effect on light scattering during measurement of the turbidity.

After setting the necessary prescribed level for the concentration of the micro flocs and the fine suspended particles with particle sizes of 0.5 to 1.0 μm at the final stage of the rapid agitation in the process 1 of the basic construction (1), based on the aforementioned proportional relationship, the G_{R0} value as the initial G_{R} value allowing this reference value to be satisfied is set to 150 s⁻¹ to 450 s⁻¹, which is employed as a feasible G_{R} value for almost all purification plants, and the initial T_{R} value is set to 5 minutes, as an usual upper limit for the rapid agitation time.

In contrast, in the process 1 of the basic construction (2), after having set the necessary prescribed level based on the turbidity in the final stage of the rapid agitation in a straightforward manner instead, an initial value G_{R0} is set as the same G_{R} value as the basic construction (1), and 5 minutes is set as the upper limit.

In the process 1 of the basic constructions (1) and (2), the minimum G_{R1} value is set with 75 s⁻¹ as a lower limit and the T_{R1} value is set with 10 minutes as a lower limit, with G_{R1}·T_{R1}=G_{R0}·5 minutes being satisfied.

The reason for setting the lower limit for the T_{R1} value to be 10 minutes is to ensure a more moderate agitation state by setting a time of 10 minutes or longer, where 10 minutes is assumed and set as the upper limit for the rapid agitation time in the prior invention already mentioned.

Setting the G_{R1} value to be smaller than the G_{R0} value and setting a maximum T_{R1} value to be at least twice the 5 minutes that is the upper limit of the normal state of use, is based on rule of thumb that when using a rapid agitation time that has been lengthened due to moderate rapid agitation intensity, a formula G_{R0}·T_{R0}=G_{R1}·T_{R1} holds and the turbidity decreases even with the same value of G_{R}·T_{R}.

Actually, when comparing the G_{R} value of 450 s⁻¹ and the T_{R} value of 5 minutes with the G_{R} value of 150 s⁻¹ and the T_{R} value of 15 minutes, using the raw water obtained from the Yodo river as the water to be treated in the rapid agitation tank 1, despite a fact that both values of G_{R}·T_{R} were equivalent at 2250×60=135,000 as shown in a respective graphs of FIG. 3, the turbidity at the stage where the rapid agitation had been completed was 0.64 degree with 450 s⁻¹×5 minutes while 0.45 degree with 150 s⁻¹×15 minutes, indicating considerable improvement in the turbidity in the latter case compared to the former case.

The reason for this improvement is understood to be that in the latter case, the smaller G_{R} value and larger T_{R} value exhibited the same function as slow agitation, lowering the remaining amount of the micro flocs with particle sizes of 15 μm or smaller and resulting in the aggregation of the micro flocs with particle sizes of greater than 15 μm.

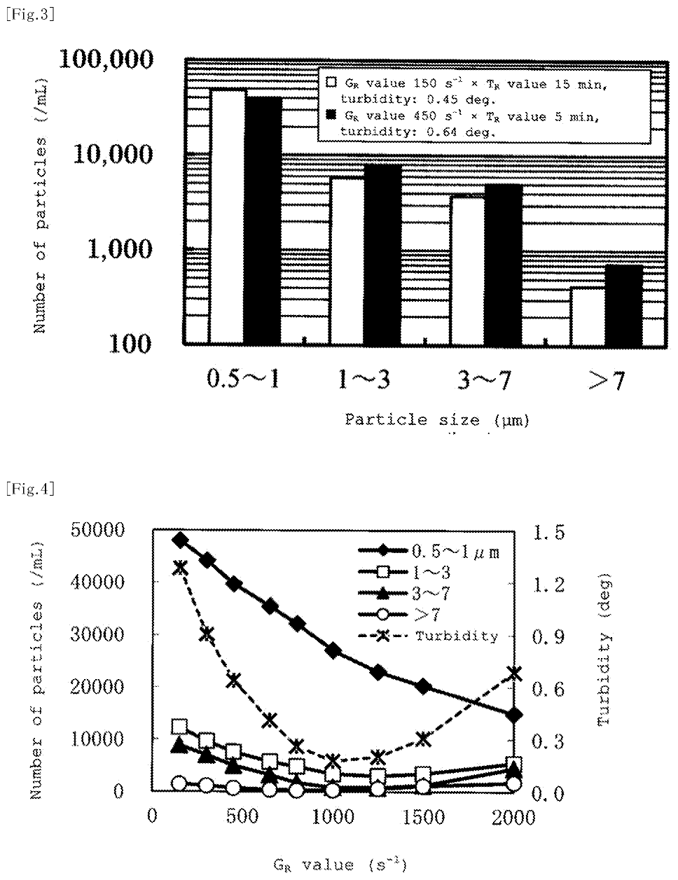

Incidentally, in graphs of FIG. 4 and FIG. 5 based on a testing rapid agitation tank, the G_{R} value of greater than 1000 s⁻¹ may result in breakup of larger micro flocs with particle sizes of 15 μm or greater, as explained above under Background Art.

Conversely, no such breakup occurred when the G_{R} value was equal to or below a prescribed numerical value, i.e. equal to or below 1000 s⁻¹, even in the testing rapid agitation tank, thus providing support that the aggregation is promoted.

Moreover, judging from the concentration N of the micro flocs and the flocs from the general formula of [Formula 3] and the approximation of [Formula 8], the improvement in the turbidity can be attributed to a larger mean volume Φ of the micro flocs or the floc particles per unit volume, on which the N depends.

The lower limit for the T_{R1} value is 10 minutes and the upper limit for the G_{R0} value is 450 s⁻¹.

Therefore, the upper limit for the G_{R1} value, calculated from 450×5=G_{R1}×10, is 225 s⁻¹.

Since the upper limit for the G_{R0} value is 450 s⁻¹ while the lower limit for the G_{R1} value is 75 s⁻¹, the upper limit for the T_{R1} value, calculated from 450×5=75×T_{R1}, is 30 minutes.

In the basic constructions (1) and (2), for selection of the G_{R} value and T_{R} value in prescribed ranges, it is essential to set the maximum G_{R} value and the minimum T_{R} value on the assumption of 10 minutes as the lower limit for the T_{R} value.

In the process 2 of the basic construction (1), within 5 minutes after starting a rapid agitation operation, after having detected the G_{R2}′ value which is the upper limit for the G_{R} value where there is no decrease in the concentration of the micro flocs and the fine suspended particles with particle sizes of 0.5 to 1.0 μm at the stage where the rapid agitation step has been completed, the maximum G_{R2} value and the minimum T_{R2} value are set by the relational expression: G_{R2}′×5 minutes=G_{R2}·T_{R2}, while in the process 2 of the basic construction (2), within 5 minutes after starting the rapid agitation operation, after having detected the G_{R2}′ value which is the upper limit for the G_{R} value where there is no increase in the turbidity at the stage where the rapid agitation step has been completed, the maximum G_{R2} value and the minimum T_{R2} value are set by the relational expression: G_{R2}′×5 minutes=G_{R2}·T_{R2}.

The reason for setting these G_{R2}′ value upper limits means that detection of the upper limit at which the concentration of the micro flocs and the fine suspended particles with particle sizes of 0.5 to 1.0 μm does not decrease (for the basic construction (1)) or detection of the upper limit at which the turbidity does not decrease (for the basic construction (2)) at the stage after completion of the rapid agitation step, after having passed the normal upper limit for the rapid agitation time, i.e. 5 minutes, means that both cases set the upper limit for the G_{R} value that avoids breakup of the larger micro flocs with particle sizes of 15 μm or greater.

In these cases, setting the maximum G_{R2} value as G_{R2}=G_{R2}′ (5/T_{R2}) by the aforementioned relational expression results in a situation in which, under the normal state of use, the breakup of the larger micro flocs naturally cannot take place, even with the maximum G_{R2} value based on the proportion of (5/T_{R2}) with respect to G_{R2}′ as the upper limit for the G_{R} value that avoids breakup of the larger micro flocs.

In addition, the turbidity at the final stage of the rapid agitation step can be further lowered with G_{R2}×T_{R2}, compared to G_{R2}′×5 minutes.

Explaining concretely, even though the G_{R2}′ value is usually well above 450 s⁻¹, the turbidity at the stage where the rapid agitation step has been completed still falls when the G_{R} value has been decreased and the T_{R} value has been increased with the same value of G_{R}·T_{R}, even if the G_{R} value is 450 s⁻¹ or greater, similar to the comparison between G_{R0}×5 minutes and G_{R1}×T_{R1}.

Actually, when 1500 s⁻¹×1.5 minutes and 450 s⁻¹×5 minutes in the graph shown in FIG. 2(a) are compared, even though both have equal G_{R}·T_{R} values of 135,000, the remaining amount of the micro flocs and the fine suspended particles with particle sizes of 0.5 to 1.0 μm is 400,000/mL in the former while 150,000/mL in the latter, demonstrating that the latter clearly has fewer.

In the case shown in the graph of FIG. 2(a), when the G_{R} value is 1500 s⁻¹, the micro flocs and the fine suspended particles in the remaining state with particle sizes of 0.5 to 1.0 μm switches to an increase at the stage where the T_{R} value is 3.5 minutes.

A cause for this increasing state comes from breakup of the larger micro flocs, and also necessarily indicates increased turbidity as well.

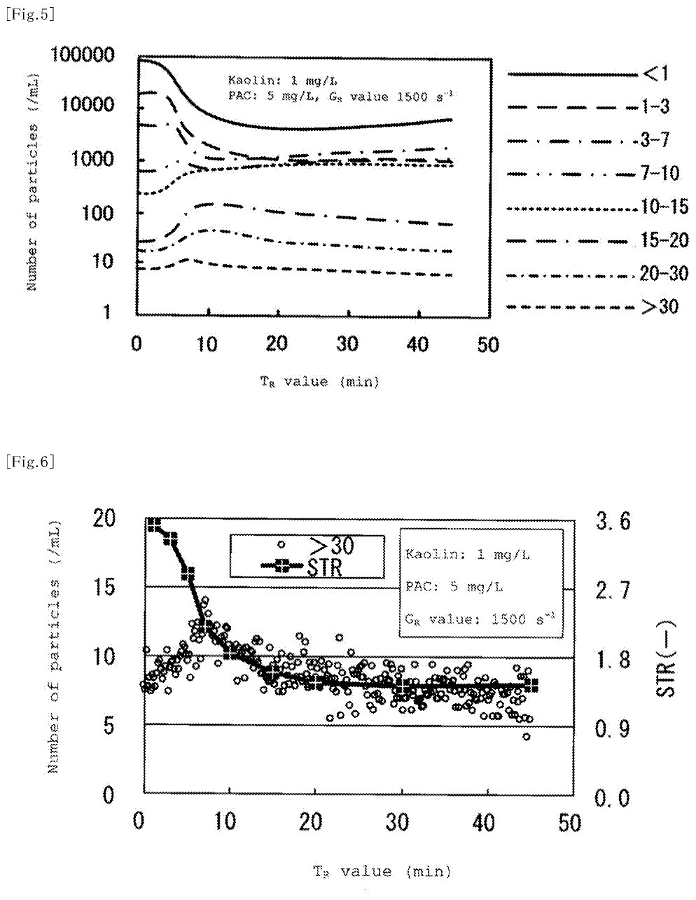

Explaining in more detail for the cause of this breakup of the larger micro flocs, FIG. 6, similar to FIG. 5, shows the state of change in the number of particles exceeding a particle size of 30 μm, and a STR value (Suction Time Ratio: a ratio as an index represented by T_{S}/T_{V}, when distilled water with the same temperature and the same amount as the water to be treated has been drawn into the same filter paper at the same drawing level, where the drawing time of the water to be treated is T_{S} and the supply time for the distilled water is T_{V}), after setting the G_{R} value to 1500 s⁻¹, in a testing rapid agitation tank used to collect data for FIG. 4.

The state of decrease in the larger micro flocs exceeding a particle size of 30 μm is identical to the state shown in FIG. 5, and the STR value successively decreases with increasing T_{R} value.

This decrease in the STR value supports an interpretation that, according to the general solution and approximation of the Smoluchowski equation shown as [Formula 3] and [Formula 8], the collision efficiency α decreases due to the effect of an inorganic coagulant and breakup of the larger micro flocs takes place associated with the rapid agitation, while the decrease creates a situation in which it is not possible to provide replenishment by formation of the larger micro flocs in approximately equal amount as the breakup.

Therefore, the 1500 s⁻¹ cannot be considered as a detected value for G_{R2}′.

In the graph of FIG. 4 where the T_{R} value is 5 minutes, the turbidity tends to increase with a G_{R} value of 1500, but the micro flocs and the fine suspended particles with particle sizes of 0.5 to 1.0 μm are decreased, which is a different state than represented in the graph of FIG. 2(a).

The main causes for this difference are that the concentration of the suspended particles, and particularly the micro flocs and the fine suspended particles with particle sizes of 0.5 to 1.0 μm, contained in the water to be treated is clearly greater in the graph of FIG. 2(a) than in FIG. 4, and that in the case of the graph of FIG. 2(a), a slow agitation step does not come afterward, whereas it does come afterwards in the case of the graph in FIG. 4.

In the case shown by the graph of FIG. 2(a), when the G_{R} value is 650 s⁻¹, the micro flocs and the fine suspended particles with particle sizes of 0.5 to 1.0 μm decreases only very slightly, and therefore the turbidity does not increase, with the rapid agitation treatment for 5 minutes, such that 650 s⁻¹ can be considered as the detected value for the upper limit G_{R2}′ value.

When the lower limit of 10 minutes is set as the minimum T_{R2} value, it is possible to set 650/2 (650/2 (S⁻¹)=325 s⁻¹ as the maximum G_{R2} value for the rapid agitation shown in the graph of FIG. 2(a).

In the operating conditions in the rapid agitation tank 1 by the process 3 of the basic constructions (1) and (2) , the G_{R3} value and the T_{R3} value are selected to satisfy G_{R1}≤G_{R3}≤G_{R2} and T_{R2}≤T_{R3}≤T_{R1}, and to satisfy G_{R3}·T_{R3}≤600,000.

In above selection, the G_{R3} value is in the range between the minimum G_{R1} and the maximum G_{R2} value while the T_{R3} value is in the range between the lower limit for the T_{R} value, i.e. T_{R2}, and the maximum T_{R1} value, but such selection allows a wide numerical range to be obtained for appropriate values of G_{R} and T_{R}.

The reason for the inequality for the G_{R3}·T_{R3} value is that the basic constructions (1) and (2) are based on a major assumption that the value of G_{R3}·T_{R3} is selected so as to be the same as the value of G_{R}·T_{R} in normal rapid agitation, making it essential to establish G_{R3}·T_{R3}≤2000×5 minutes×60=600,000.

In contrast, the lower limit for the value of G_{R}·T_{R} in the normal rapid agitation is 150 (s−¹)×1 minute×60=9000, but the lower limit for the G_{R3}·T_{R3} value is 75×10×60=45000, which is clearly larger than the above-mentioned lower limit of 9000, and therefore the conditions for the lower limit do not necessarily need to be set.

The following is the reason that selection of the G_{R3} value and the T_{R3} value in the process 3 allows energy consumption to be reduced per rapid agitation unit.

As is already explained, the following formula:

P=μG_{R}² [Formula 9]

(where μ is the viscosity coefficient)
holds between the energy P required for rapid agitation per unit time and unit volume in the rapid agitation tank 1 per unit time and unit volume, and the G_{R} value.

Therefore, the following formula holds for the energy consumption, when also taking into account the rapid agitation time for the rapid agitation, with selection of the G_{R3} value and T_{R3} value in process 3:

$$\begin{matrix}P \cdot {T}_{R 3} = μ {G}_{R 3}^{2} \cdot {T}_{R 3} \\ = μ ( {G}_{R 3} \cdot {T}_{R 3} ) {G}_{R 3} .\end{matrix} \qquad [ Formula 10 ]$$

In the normal rapid agitation state, where the numerical value for the rapid agitation intensity is set in the range of 150 s⁻¹ to 2000 s⁻¹ and the numerical value for the rapid agitation time is set in the range of 1 minute to 5 minutes, and with the G_{R} value and the T_{R} value as G_{R}′ and T_{R}′, respectively, so long as 150 s⁻¹≤G_{R}′≤2000 s⁻¹ holds and 1 minute≤T_{R}′≤5 minutes holds, then 9000≤G_{R}′·T_{R}′≤600,000 also holds.

Therefore, so long as the numerical range for the value of G_{R}′·T_{R}′ is larger than the numerical range for the value of G_{R3}′·T_{R3}′, then for the G_{R}′·T_{R}′ value it is of course possible to set a state in which the following formula:

G_{R}′·T_{R}′=G_{R3}′·T_{R3}′ [Equation 11]

holds between the G_{R3} value and the T_{R3} value, i.e. a state in which the concentrations N of the micro flocs and the flocs are theoretically equal at the stage where the rapid agitation step has been completed.

In this relational expression, T_{R}′≤5 minutes<10 minutes ≤T_{R3} holds, and therefore G_{R}′>G_{R3} holds.

Therefore, the following equality holds:

P·T_{R3}=μ(G_{R}′·T_{R}′)G_{R3}

[symbol]

μ(G_{R}′·T_{R}′)G_{R}′. [Formula 12]

As is also clear from the inequalities shown above, with the G_{R3} value and the T_{R3} value selected by the process 3 of the basic constructions (1) and (2), it is possible to produce a state with smaller energy consumption for the rapid agitation, compared to normal use with the G_{R}′ value and the T_{R}′ value that realize the same concentration N.

By comparing the G_{R} value of 1500 s⁻¹ and the other numerical values in FIG. 2(a), it is also clearly seen that, in a state of the normal rapid agitation, when the G_{R} value has exceeded a prescribed limit within the rapid agitation time of no longer than 5 minutes, this can result in an increased remaining amount of the micro flocs and the fine suspended particles with particle sizes of 0.5 to 1.0 μm at the final stage of the rapid agitation due to breakup of the larger micro flocs, and therefore the increased turbidity, but such increase associated with breakup is impossible with the basic constructions (1) and (2) where the G_{R3} value and the T_{R3} value are selected by the process 3.

Furthermore, apart from presence or absence of the aforementioned breakup of the larger micro flocs, the turbidity at the stage where the rapid agitation step has been completed decreases compared to the normal state of use even with the same value of G_{R}·T_{R}, due to selecting a small G_{R} value and a large T_{R} value, and specifically by a fact that G_{R}′>G_{R3}, T_{R}<T_{R3} are satisfied with respect to the G_{R}′ value and the T_{R}′ value that have been set in the normal state of use, as has already been explained with reference to FIG. 2(a) and FIG. 3.

Individual embodiment will now be explained.

In the basic constructions (1) and (2), it is possible to employ an embodiment according to the prior invention, having the requirement and feature of, as the final stage of the flocculation step, providing the floc-forming inclined plate 20 whose pitch width is from 5 mm or more to 50 mm or less and also using the inorganic coagulant at a stage after the micro flocculation step in a limited manner so that the turbidity of the water to be treated after passage through the inclined plate 20 is at a ratio of 4/5 or less than a ratio before the passage.

When such embodiment is employed, it is possible to achieve an effect of obtaining high-quality clear water by forming refined and highly densified micro flocs similar to the prior invention, while also decreasing the amount of sludge generated in association with use of the inorganic coagulant, in addition to achieving the effect of the present invention.

In order to minimize P·T_{R} as the energy consumption for the rapid agitation, the minimum G_{R1} value is selected as the G_{R3} value and the maximum T_{R1} value is selected as the T_{R3} value in the process 3.

This is because when the value of G_{R}·T_{R} is constant, the energy consumption is proportional to the value G_{R} of the rapid agitation intensity, as is also clear from a general formula for P·T_{R}.

If the G_{R3} value and the T_{R3} value are selected in the process 3 for each of the basic constructions (1) and (2) in a manner so as to result in the lowest turbidity, then it is possible to realize suitable aggregation and sedimentation of the water to be treated in the subsequent purification treatment.

In actual practice, in light of the comparison between 1500 s¹×1.5 minutes and 450 s⁻¹×5 minutes in FIG. 2(a), and comparison between 450 s⁻¹×5 minutes and 150 s⁻¹×15 minutes in FIG. 3, selection of the lowest turbidity is interpreted as, in practice, meaning selection of the minimum G_{R1} value for minimizing the energy consumption P·T_{R}.

As is explained above, the numerical value that is set as the G_{R0} value selected within the range of 150 s⁻¹ to 450 s⁻¹ depends on a specific conditions in the rapid agitation tank.

However, complex experimentation is necessary to judge what a suitable upper limit is in practice.

In such cases, when 450 s⁻¹ is set as the initial G_{R0} value in the process 1 of the basic constructions (1) and (2), while in the process 3, 150 s⁻¹ is set as the G_{R2} value, 150 s⁻¹ is selected as the G_{R3} value, 15 minutes is set as the T_{R2} value, and 15 minutes is selected as the T_{R3} value, as shown in FIG. 3, this will be suitable for almost all rapid agitation tanks, and it will also be possible to both ensure satisfactory turbidity and accomplish efficient rapid agitation, and to eliminate need for the aforementioned complex experimentation.

Examples of the invention will now be described.

### EXAMPLE 1

Example 1 is characterized in that as the amount of the water to be treated increases, the G_{R3} value increases and the T_{R3} value decreases, and as the amount of the water to be treated decreases, the G_{R3} value decreases and the T_{R3} value increases.

The reason of such a character is based on a fact that the increase and the decrease in the water to be treated must necessarily match the increase and the decrease in the water to be treated per unit time passing through the rapid agitation tank 1, and as a result, the peripheral speed v of the rapid agitation tank 1 must be increased or decreased to match it, as per the following formula:

$${G}_{R} = \sqrt{\frac{( C \cdot A \cdot {v}^{3} )}{2 \cdot γ \cdot V}} \qquad [ Formula 13 ]$$

which also requires the increase or the decrease in the G_{R} value.

Because of this feature, it is possible to maintain a function of the rapid agitation tank 1 while exhibiting the effect of the present invention, adapting to the increase and the decrease in the water to be treated.

### EXAMPLE 2

Example 2 is characterized in that the amount of the inorganic coagulant used increases as the amount of the water to be treated increases, and the amount of the inorganic coagulant used decreases as the amount of the water to be treated decreases.

Adjustment of the amount of the inorganic coagulant used depending on the amount of the water to be treated is also obvious from common technical knowledge.

In addition, based on the general formula mentioned above:

N=A exp(−4αΦG_{R}T_{R}/π) [Formula 14]

(where A: initial value of the N at the stage t=0),
the collision efficiency α is kept in a constant state by adjusting the amount of the inorganic coagulant used regardless of any increase or decrease in the water to be treated, and consequently the concentration N of the micro flocs and the flocs, which reflect the turbidity, can be kept constant.

### INDUSTRIAL APPLICABILITY

The present invention makes it possible to reduce the energy consumption per the rapid agitation unit, compared to the normal state of use of the rapid agitation tank, and to ensure more satisfactory turbidity, allowing it to be utilized for the coagulation sedimentation treatment of almost any type of the water to be treated.

### REFERENCE SIGNS LIST

1 Rapid agitation tank
2 Sedimentation basin
20 Inclined plate
3 Coarse grain filtration tank
4 Sand filtration tank

1. A method of coagulation sedimentation process for water to be treated, the process having an inorganic coagulant injection step of injecting an inorganic coagulant into water to be treated, a micro flocculation step of fine suspended particles in the water to be treated with mixing and agitating the water to be treated in a rapid agitation tank into which the inorganic coagulant has been injected to micro-flocculate in advance, a flocculation step including a step in which micro flocs are further flocculated according to contact with already existing flocs in a sedimentation basin, and a sedimentation separation step of effecting sedimentation and separation of the flocs in the sedimentation basin, wherein a G_{R} value as a rapid agitation intensity and a T_{R} value as a rapid agitation time, represented by following formulas, are selected by following processes:
$${G}_{R} = \sqrt{\frac{( C \cdot A \cdot {v}^{3} )}{2 \cdot γ \cdot V}} \qquad [ Formula 1 ]$$
Where C: agitation constant, A: agitation blade area (m²), v: agitation blade peripheral speed (m/s), γ: kinematic viscosity coefficient (m²/s), V: agitation tank volume (m³)
1. In order to satisfy a necessary prescribed level for a concentration of the micro flocs and the fine suspended particles with particle sizes of 0.5 to 1.0 μm at a stage where a rapid agitation step has been completed, initial values for the G_{R} value and the T_{R} value are respectively set to a G_{R0} value in a range of 150 s⁻¹ to 450 s⁻¹ and 5 minutes, and a minimum G_{R1} value is set with 75 s⁻¹ as a lower limit and a maximum T_{R1} value is set with 10 minutes as a lower limit with G_{R1}·T_{R1}=G_{G0}·5 minutes being satisfied,
2. Within 5 minutes after starting a rapid agitation operation, after having detected a G_{R2}′ value which is an upper limit for the G_{R} value where there is no decrease in the concentration of the micro flocs and the fine suspended particles with particle sizes of 0.5 to 1.0 μm at the stage where the rapid agitation step has been completed, a maximum G_{R2} value and a minimum T_{R2} value are set by a relational expression of G_{R2}′×5 minutes=R_{R2}·T_{R2}, and,
3. As operating conditions at the rapid agitation tank, a G_{R3} value and a T_{R3} value are selected to satisfy G_{R1}≤G_{R2}≤G_{R2}, T_{R2}≤T_{R2}≤T_{R1}, and to satisfy G_{R3}·T_{R3}≤600,000.

2. The method of coagulation sedimentation process for water to be treated according to claim 1, wherein as a final stage of the flocculation step, a floc-forming inclined plate whose pitch width is from 5 mm or more to 50 mm or less is provided and the inorganic coagulant at a stage after the micro flocculation step is limited for used amount so that turbidity of the water to be treated after passage through the inclined plate is at a ratio of 4/5 or less than a ratio before the passage.

3. The method of coagulation sedimentation process for water to be treated according to claim 1, wherein the minimum G_{R1} value is selected as the G_{R3} value and the maximum T_{R1} value is selected as the T_{R3} value.

4. The method of coagulation sedimentation process for water to be treated according to claim 1, wherein, in a final stage of the rapid agitation tank, the G_{R3} value and the T_{R3} value are selected so that the turbidity is to be a minimum value.

5. The method of coagulation sedimentation process for water to be treated according to claim 1 wherein, after setting 450 s⁻¹ as the G_{R0} value, and 150 s⁻¹ is set as the G_{R2} value, and moreover 150 s⁻¹ is selected as the G_{R3} value, while 15 minutes is set as the T_{R2} value and 15 minutes is selected as the T_{R3} value.

6. The method of coagulation sedimentation process for water to be treated according to claim 1 wherein, as the amount of the water to be treated increases, the G_{R3} value increases and the T_{R3} value decreases, and as the amount of the water to be treated decreases, the G_{R3} value decreases and the T_{R3} value increases.

7. The method of coagulation sedimentation process for water to be treated according to claim 1, wherein the amount of the inorganic coagulant used increases as the amount of the water to be treated increases, and the amount of the inorganic coagulant used decreases as the amount of the water to be treated decreases.

8. A method of coagulation sedimentation process for water to be treated, the process having an inorganic coagulant injection step of injecting an inorganic coagulant into water to be treated, a micro flocculation step of fine suspended particles in the water to be treated with mixing and agitating the water to be treated in a rapid agitation tank into which the inorganic coagulant has been injected to micro-flocculate in advance, a flocculation step including a step in which micro flocs are further flocculated according to contact with already existing flocs in a sedimentation basin, and a sedimentation separation step of effecting sedimentation and separation of the flocs in the sedimentation basin, wherein a G_{R} value as a rapid agitation intensity and a T_{R} value as a rapid agitation time, represented by following formulas, are selected by following processes:
$${G}_{R} = \sqrt{\frac{( C \cdot A \cdot {v}^{3} )}{2 \cdot γ \cdot V}} \qquad [ Formula 2 ]$$
Where C: agitation constant, A: agitation blade area (m²), v: agitation blade peripheral speed (m/s), γ: kinematic viscosity coefficient (m²/s), V: agitation tank volume (m³)
1. In order to satisfy a necessary prescribed level for turbidity at a stage where a rapid agitation step has been completed, initial values for the G_{R} value and the T_{R} value are respectively set to a G_{R0} value in a range of 150 s⁻¹ to 450 s⁻¹ and 5 minutes, and a minimum G_{R1} value is set with 75 s⁻¹ as a lower limit and a maximum T_{R1} value is set with 10 minutes as a lower limit with G_{R1}·T_{R1}=G_{R0}·5 minutes being satisfied,
2. Within 5 minutes after starting a rapid agitation operation, after having detected a G_{R2}′ value which is an upper limit for the G_{R} value where there is no increase in the turbidity at a stage where the rapid agitation step has been completed, a maximum G_{R2} value and a minimum T_{R2} value are set by a relational expression of G_{R2}′×5 minutes=G_{R2}·T_{R2}, and
3. As operating conditions at the rapid agitation tank, a G_{R3} value and a T_{R3} value are selected to satisfy G_{R1}≤G_{R3}≤G_{R2}, T_{R2}≤T_{R3}≤T_{R1}, and to satisfy G_{R3}·T_{R3}≤600,000.

9. The method of coagulation sedimentation process for water to be treated according to claim 8, wherein as a final stage of the flocculation step, a floc-forming inclined plate whose pitch width is from 5 mm or more to 50 mm or less is provided and the inorganic coagulant at a stage after the micro flocculation step is limited for the used amount so that the turbidity of the water to be treated after passage through the inclined plate is at a ratio of 4/5 or less than a ratio before the passage.

10. The method of coagulation sedimentation process for water to be treated according to claim 8, wherein the minimum G_{R1} value is selected as the G_{R3} value and the maximum T_{R1} value is selected as the T_{R3} value.

11. The method of coagulation sedimentation process for water to be treated according to claim 8, wherein, in a final stage of the rapid agitation tank, the G_{R3} value and T_{R3} value are selected so that the turbidity is a minimum value.

12. The method of coagulation sedimentation process for water to be treated according to claim 8 wherein, after setting 450 s⁻¹ as the G_{R0} value, 150 s⁻¹ is set as the G_{R2} value and 150 s⁻¹ is selected as the G_{R3} value, while 15 minutes is set as the T_{R2} value and 15 minutes is selected as the T_{R3} value.

13. The method of coagulation sedimentation process for water to be treated according to claim 8 wherein, as the amount of the water to be treated increases, the G_{R3} value increases and the T_{R3} value decreases, and as the amount of the water to be treated decreases, the G_{R3} value decreases and the T_{R3} value increases.

14. The method of coagulation sedimentation process for water to be treated according to claim 8, wherein the amount of the inorganic coagulant used increases as the amount of the water to be treated increases, and the amount of the inorganic coagulant used decreases as the amount of the water to be treated decreases.
